(19) United States
(12) Patent Application Publication
(10) Pub. No.: US 2025/0144716 A1
(43) Pub. Date: May 8, 2025

(54) CUTTING TOOL WITH CUTTING HEAD AND CUTTING HEAD DRIVER

(71) Applicant: Gühring KG, Albstadt (DE)

(72) Inventors: Uwe SCHLAGENHAUF, Albstadt (DE); Gilbert KLEINER, Inzigkofen (DE)

(73) Assignee: Gühring KG, Albstadt (DE)

(21) Appl. No.: 18/838,214

(22) PCT Filed: Mar. 15, 2023
(86) PCT No.: PCT/EP2023/056605

§ 371 Date: Aug. 13, 2024

(30) Foreign Application Priority Data
Mar. 16, 2022 (DE) 10 2022 106 206.6
May 17, 2022 (DE) 10 2022 112 301.4

(51) Int. Cl. B23B 27/16

(52) U.S. Cl. CPC B23B 27/16

(57) ABSTRACT

A cutting tool (2) for machining workpieces includes a cutting head (10) and a cutting head driver (12) which can be connected to the cutting head (10). The cutting head (10) and the cutting head driver (12) have respective main parts (14, 24), from the end face of which a protruding section (16, 26) that has an undercut in the axial direction protrudes axially, each protruding section having a torque-transmitting surface (18, 28) which are designed to complement each other, are positioned in a preferably axial manner, and rest against each other in the connected state, wherein the protruding sections (16, 26) are dimensioned such that the end face (20) of the protruding section (16) of the cutting head (10) rests against the end face (32) of the main part (24) of the cutting head driver (12) in the axial direction in the connected state.

### CROSS-REFERENCE TO RELATED APPLICATION

This application is a national stage application, filed under 35 U.S.C. § 371, of International Patent Application PCT/EP2023/056605, filed on Mar. 15, 2023, which claims the benefit of German Patent Applications DE 10 2022 106 206.6, filed on Mar. 16, 2022, and DE 10 2022 112 301.4, filed on May 17, 2022.

### TECHNICAL FIELD

The present disclosure relates to a cutting tool for machining workpieces, in particular a shaft tool, such as a milling cutter or a drill. The cutting tool has a cutting head, preferably made of hard metal, and a cutting head driver, preferably made of steel. The cutting head and the cutting head driver can be connected to one another via a type of bayonet closure/via a bayonet connection, in particular in a torque-transmitting and axially fixed.

### BACKGROUND

Such cutting tools constructed of multiple pieces, which can be connected to one another in a bayonet-like manner for the torque transmission and axial connection, are already known from the prior art. The DE 10 2017 214 165 B4, for example, discloses a rotary tool with a carrier and a cutting insert, in the case of which the carrier can be inserted in a seat of the cutting insert and abuts with its side surfaces against respective side surfaces of the cutting insert in the inserted state.

The cutting head and the cutting head driver can thereby be made of different materials/substances, of the same substance group, preferably steel, or different substance groups, preferably of hard metal and steel, in order to optimize the cutting tool with regard to wear resistance, strength as well as costs, as required.

It is a disadvantage of known cutting tools, however, that due to the lever-like effect at the bayonet connection, a bending stress is induced between the cutting head and the cutting head driver, which must not become too high in particular in the case of a formation of the cutting head and of the cutting head driver from different materials in the region of the cutting head or of a part of the cutting tool formed from hard metal, respectively, in order to avoid damages.

A cutting tool of a cutting head driver and a cutting head, which can be connected to one another via cutting head-side and cutting head driver-side coupling sections, in each case further known from the DE 10 2013 205 889 B3, the DE 10 2012 200 690 B4, the EP 0 984 841 B2 and the DE 697 34 937 T2. In the connected state, the coupling sections thereby engage with recesses of the cutting head or cutting head driver, respectively, which are in each case recessed on the end face, i.e., with respect to the end face of the coupling sections, and abut against one another on torque-transmitting surfaces, which are each formed in a complementary manner, for the torque-transmitting/stop surfaces and fastening surfaces/clamping surfaces for the centering, fastening and/or clamping.

In the case of the cutting tool known from the DE 10 2013 205 889 B3 or the DE 10 2012 200 690 B4, the cutting head-side coupling sections are formed by means of a coupling pin, which is diametrically continuous but does not extend all the way to the outer tool radius, and the cutting head driver-side coupling sections are formed by means of spaced-apart/individual webs/protrusions, which lie diametrically opposite one another and which have an essentially ring section-shaped cross section. In the connected state, the cutting head driver-side coupling sections surround the cutting head-side coupling sections radially on the outside. The coupling pin on the cutting head has an approximately rectangular basic shape, in the case of which longitudinal sections and transverse sections merge over transition sections formed as rounded corner sections, wherein the longitudinal sections form the torque-transmitting surfaces/stop surfaces and the transverse sections form the fastening surfaces/clamping surfaces. For the axial securing, the longitudinal sections and/or transverse sections are axially undercut, for example in the manner of a dovetail joint. In the connected state, the cutting head driver-side coupling sections abut axially against the recessed recesses of the cutting head, while the cutting head-side coupling sections are axially spaced apart from the recessed recesses of the cutting head driver.

In the case of the cutting tool known from the EP 0 984 841 B2, the cutting head-side coupling sections are formed by means of a web on the cutting head, which extends diametrically continuously, and the cutting head driver-side coupling sections are formed by means of spaced-apart/individual protrusions, which lie diametrically opposite one another. The torque-transmitting surfaces are axially adjusted and extend essentially in the radial direction. The fastening surfaces extend concentrically to the axis of rotation in the circumferential direction. In the connected state, the cutting head driver-side coupling sections abut axially against the recessed recesses of the cutting head, while the cutting head-side coupling sections are axially spaced apart from the recessed recesses of the cutting head driver.

In the case of the cutting tool known from the DE 697 34 937 T2, the cutting head-side coupling sections are formed by means of a coupling pin, which extends diametrically continuously all the way to the outer tool radius, and the cutting head driver-side coupling sections are formed by means of spaced-apart/individual webs/protrusions, which lie diametrically opposite one another and which have an essentially ring section-shaped cross section. The fastening surfaces extend concentrically to the axis of rotation in the circumferential direction and are axially adjusted for the axial securing, in particular aligned radially inwards and longitudinally backward, so that a dovetail-like cross section develops in the region of the fastening surfaces. The torque-transmitting surfaces extend in the radial direction and are aligned parallel to the axis of rotation, i.e., are not axially adjusted. In the connected state, the cutting head-side coupling sections abut axially against the recessed recesses of the cutting head driver, while the cutting head driver-side coupling sections are axially spaced apart from the recessed recesses of the cutting head.

It is a disadvantage of these rotary tools, however, that they have weak spots in terms of material failure and are not suitable for transmitting particularly high torques. In addition, the production of the geometry of the coupling pin or the dovetail-like external geometry, respectively, is complex, for instance by means of a downstream milling.

### SUMMARY

It is an object of the present disclosure to avoid the mentioned disadvantages of known cutting tools and to provide a multi-piece cutting tool, which can withstand high forces, without having to accept the risk of damages or the premature wear of its individual components.

The object of the present disclosure is solved by a cutting tool with the features as claimed.

The cutting head and the cutting head driver each have a main body, from the end face of which a protrusion section undercut in the axial direction protrudes axially. This means that the protrusion section of the cutting head protrudes from the (axial) end face of the main body of the cutting head in the axial direction towards the cutting head driver. The protrusion section of the cutting head is thereby formed to be undercut in particular in an axial direction directed away from the cutting head driver. This also means that the protrusion section of the cutting head driver protrudes from the (axial) end face of the main body of the cutting head driver in the axial direction towards the cutting head. The protrusion section of the cutting head driver is thereby formed to be undercut in particular in an axial direction directed away from the cutting head. In other words, the cutting head and the cutting head driver in each case have end faces, which lie opposite one another and which are formed in a stepped manner, in the case of which the axially external (or outermost) part, respectively, of the end face is formed by means of the end face of the corresponding protrusion section and the axially recessed/internal part of the end face is formed by means of the end face of the corresponding main body. The protrusion sections thereby in each case undercut the end face of the corresponding main body in opposite axial directions.

The protrusion section of the cutting head and the protrusion section of the cutting head driver can be connected to one another in a positive manner/can be brought into positive engagement with one another by rotating the cutting head against a cutting direction of the cutting tool. By rotating the cutting head in the cutting direction, the protrusion section of the cutting head and the protrusion section of the cutting head driver can be released from one another/can be released from positive engagement. This means that the bayonet closure/the bayonet connection is formed in such a way by means of the axially undercut protrusion sections that the cutting head and the cutting head driver can be connected to one another by means of mutual rotation and can be released from one another by means of opposite mutual rotation. The protrusion sections serve in particular as coupling sections for connecting the cutting head and the cutting head driver.

The protrusion section of the cutting head and the protrusion section of the cutting head driver have torque-transmitting surfaces, which are in each case formed complementary to one another, are undercut in the axial direction and are preferably axially adjusted and which, in the connected state of the cutting head and of the cutting head driver, abut against one another, in particular in a flat manner. This means that the protrusion section of the cutting head is formed in a wedge-shaped manner or has a wedge-shaped section, which forms the torque-transmitting surface/undercutting surface of the protrusion section. The torque-transmitting surface of the protrusion section of the cutting head can preferably be aligned essentially in the radial direction, i.e., perpendicular to the tangential direction, of the cutting tool, in order to be able to absorb a torque, which the cutting head driver is to transmit to the cutting head, in a positive manner. This also means that the protrusion section of the cutting head driver is formed in a wedge-shaped manner or has a wedge-shaped section, which forms the torque-transmitting surface/undercutting surface of the protrusion section. The torque-transmitting surface of the protrusion section of the cutting head driver can preferably be aligned essentially in the radial direction, i.e., perpendicular to the tangential direction of the cutting tool, in order to be able to transfer a torque, which the cutting head driver is to transmit to the cutting head, in a positive manner. In other words, the cutting head and the cutting head driver are formed/stepped essentially in a Z-shaped manner in the region of their (bayonet) connection.

In the case of the cutting tool, the protrusion sections of the cutting head and of the cutting head driver in the case of the cutting tool are dimensioned so that an end face of the protrusion section of the cutting head abuts against an end face of the main body of the cutting head driver in the axial direction in the connected state. This means that the protrusion sections are dimensioned so that or that their tolerances are selected so that, when the torque-transmitting surfaces of the protrusion sections abut against one another (and transmit a torque), i.e., in the connected state of the cutting head and of the cutting head driver, the protrusion section of the cutting head axially supports itself on the main body of the cutting head driver. In other words, the wedge-shaped protrusion section of the cutting head is received in a wedge-shaped recess, which is formed by means of the protrusion section and the main body of the cutting head driver so as to abut against it axially and tangentially in the connected state, or the wedge-shaped section of the cutting head supports itself with both wedge sides in the wedge-shaped recess of the cutting head driver, respectively.

This has the advantage that due to the axial support of the cutting head on the cutting head driver, a tangential positive guidance of the cutting head, which is preferably constructed from hard metal, results, which reduces the bending stress, in particular in the region of a transition between the protrusion section and the main body of the cutting head. Due to the axial contact between the end face of the main body of the cutting head driver and the end face of the protrusion section of the cutting head, a wedge support is additionally created, which, in the axial direction, acts in the direction to the cutting head driver and thus generates a frictional force, which counteracts the load and thus likewise reduces the bending stress, in particular in the region of the transition between the protrusion section and the main body of the cutting head.

Compared to the above-discussed cutting tools from the DE 10 2013 205 889 B3, the DE 10 2012 200 690 B4 and the EP 0 984 841 B2, this thus has the advantage that especially the cutting head driver-side coupling sections do not abut axially against the recessed recesses of the cutting head (and the cutting head-side coupling sections are axially spaced apart from the recessed recesses of the cutting head driver) but that the cutting head-side coupling sections abut axially against the recessed recesses of the cutting head driver. According to the present disclosure, the spreading takes place thereby, which results from the axial adjustment of the torque-transmitting surfaces or wedge-shaped formation of the protrusion sections, respectively (exclusively or predominantly, respectively) in the region of the wedge-shaped recess of the cutting head driver and not in the region of the wedge-shaped recess of the cutting head.

With regard to the above-discussed cutting tool from the DE 697 34 937 T2, the basic difference that an axial undercut, in particular in the shape of a dovetail, is formed there only on the fastening surfaces of the coupling pin, which serves exclusively for the fastening, in particular for the axial securing and centering is further at hand. Due to the fact that these fastening surfaces cannot transmit a torque due to their formation, which is concentric to the axis of rotation, they do not correspond to the torque-transmitting surfaces according to the present disclosure. In the case of the cutting tool of the DE 697 34 937 T2, the stop surfaces, which serve as torque-transmitting surfaces, are formed parallel to the axis of rotation, so that the core or the problem, respectively, of the present disclosure, namely of the torque-transmitting surfaces, which are undercut in the axial direction, is converted into axial forces by means of the cutting forces developing during the workpiece machining and a spreading develops, is not present in the DE 697 34 937 T2.

According to a preferred embodiment, an end face of the protrusion section of the cutting head driver can be spaced apart with axial play from an end face of the main body of the cutting head in the connected state. In other words, only one end face of the stepped end face of the cutting head abuts against the cutting head driver in order to avoid a double fit. The wedge-shaped section of the cutting head driver thus contacts the wedge-shaped recess in the cutting head only with one wedge side, more precisely with the torque-transmitting surface, and thus does not spread open the wedge-shaped recess in the cutting head. A stress of the transition between the torque-transmitting surface and the non-abutting end face is thus decreased, which has an advantageous impact on the service life of the cutting head and thus of the cutting tool.

According to the invention, the loads resulting from the wedge forces are, in general terms, moved into that section, which, by comparison, is the more flexurally elastic, softer or less brittle section, in the case of a bayonet-like connection between two sections, preferably made of different materials, e.g., steel and hard metal, alternatively made of materials from the same substance group, e.g., steel, with an alternate interior angle geometry or with two wedge geometries mutually engaging behind one another, respectively.

According to a preferred embodiment, the protrusion section of the cutting head can be formed to be longer in the axial direction than the protrusion section of the cutting head driver. It can thus be ensured in a particularly simple way that in the case of a complementary formation of the torque-transmitting surfaces, the (slight) length difference in the axial extension of the two protrusion sections entails that the cutting head abuts with its protrusion section against the main body of the cutting head driver, while the (shorter) protrusion section of the cutting head driver remains spaced apart from the main body of the cutting head. The contact surfaces, and thus force-transmitting surfaces, can thus be specified in a structurally unambiguous way.

According to a preferred embodiment, the protrusion sections can have surfaces or geometries, which interlock when connecting the cutting head and the cutting head driver. The wedge-shaped protrusion section of the cutting head and the wedge-shaped recess of the cutting head driver, for example, can have surfaces or geometries, which interact positively with one another or interlock, respectively, or achieve a locking in the direction of rotation, respectively, when connecting the two sections in the direction of rotation. An unintentional release can thus be avoided. Due to the fact that the wedge-shaped section is made of more flexurally resistant material and the wedge-shaped recess is made of more flexurally elastic material, the former can spread open the latter in a flexurally elastic manner for the locking of the surfaces or geometries.

According to a preferred embodiment, the cutting head and the cutting head driver can have complementary geometries, so that the cross section of the cutting head driver and the cross section of the cutting head essentially correspond to one another at their separating plane and/or a geometric shape of the cutting head driver, in particular a formation of a coiling, of clamping grooves and/or circumferential cutting edges, is continued through the cutting head. This means that the cutting head and the cutting head driver preferably have complementary geometries, so that the cross section of the cutting head after the stepped separating plane of both parts essentially corresponds to the cross section of the cutting head driver in front of the stepped separating plane or the geometric shape (including coiling, clamping grooves and circumferential cutting edges) of the cutting head after the connecting point continues the geometric shape (including coiling, clamping grooves and circumferential cutting edges) of the cutting head driver, respectively.

According to a preferred embodiment, the torque-transmitting surfaces can be axially adjusted in such a way that the cutting head is pushed axially in the direction to the cutting head driver by means of cutting forces acting during workpiece machining. This means that with increasing cutting forces during the workpiece machining, the cutting head is tightened more strongly to the cutting head driver due to the interaction between the axially adjusted torque-transmitting surfaces. A fixed connection between the cutting head and the cutting head driver is thus ensured in particular in the case of high cutting speeds.

In the case of the cutting tool, the torque-transmitting surfaces are preferably formed in such a way that a tangential force, which develops due to cutting forces acting during workpiece machining, is converted into an axial force so that the cutting head is pushed axially into abutment against the cutting head driver. This has the effect that with increasing cutting forces, i.e., in the case of higher speeds, the tangential increases and the axial force thus also increases, whereby the connection between the cutting head and the cutting head driver is intensified, in turn. In spite of the multi-piece setup of the cutting tool, particularly high cutting forces can be transmitted thereby.

According to a preferred embodiment, the torque-transmitting surfaces can be axially adjusted with an axial angle of attack, preferably from 2° to 15°, more preferably from 2° to 10°, particularly preferably from 2° to 5°, in particular of 3°. Such an angle of attack has proven to be sufficient in order to create a fixed connection, which can be mounted easily at the same time. Due to the selection of the axial angle of attack, the forces acting on the protrusion section are additionally kept to be as small as possible.

The torque-transmitting surface of the cutting head and the torque-transmitting surface of the cutting head driver can preferably have identical axial angles of attack. This means that the torque-transmitting surfaces abut flat against one another, so that the cutting head and the cutting head driver do not jam in the region of the torque-transmitting surface.

According to a preferred embodiment, the axial angle of attack can be constant over the entire circumferential extension/circumferential contour, i.e., the entire course in the circumferential direction, of the torque-transmitting surfaces. This means that the circumferential surfaces of the protrusion sections have the same axial angle of attack at least in the region, in which the cutting head and the cutting head driver abut against one another in the connected state, preferably over the entire extension in the circumferential direction, i.e., also in the non-abutting region. The course of the torque transmission can preferably be seamless in the circumferential direction, i.e., without bend. It is made possible thereby to finish machine all circumferential surfaces in one workpiece clamping assembly, i.e., without re-clamping and in particular with only one type of machining.

According to a preferred embodiment, the axial angle of attack can be constant over the entire axial extension, i.e., the entire course in the axial direction, of the torque-transmitting surfaces. The course of the torque-transmitting surfaces in the axial direction can preferably be seamless, i.e., without bend. This means that the axial angle of attack does not change, preferably from the end face of the protrusion section (optionally minus an end-face end region, in which a bevel or the like is formed) all the way to the end face of the main body.

The torque-transmitting surfaces can in particular be formed by means of a continuous, oblique surface, i.e., in particular without depressions or steps/elevations. This can be achieved, for example, by means of a grinding wheel machining. The continuous formation has the advantage that edges and thus peak stresses are avoided.

The cutting head and the cutting head driver can further be formed in a Z-shaped manner in the region of their bayonet closure.

The Z shape can in particular develop in that the cutting head and the cutting head driver in each case have an end face pair of two end faces, which in each case extend perpendicular to the axial direction and which are spaced apart from one another in the axial direction, and wherein the torque-transmitting surfaces, which connect the respective end faces of an end face pair to one another, in each case extend essentially continuously, i.e. aside from a transition region between the end faces and the torque-transmitting surfaces, obliquely to the axial direction between the end faces of the respective end face pair.

According to a preferred embodiment, an axially outer end face of the end face pair can transition into the torque-transmitting surface via a bevel. This means that the essentially wedge-shaped protrusion sections are beveled in an obtuse or linear manner, respectively, on their end face/wedge corner. In other words, a beveled surface is present instead of a tip (which develops due to the convergence of the axially outer end face and of the torque-transmitting surface) of the wedge-shaped protrusion sections. Not only the insertion of the protrusion sections is simplified thereby but an application of force deep into the wedge-shaped recess and local notch stress peaks is prevented.

According to a preferred embodiment, an axially inner end face of the end face pair can transition into the torque-transmitting surface via a radius. This means that the essentially wedge-shaped recesses are formed to be rounded on their wedge corner. In other words, a rounded surface is present instead of a tip (which develops due to the convergence of the axially inner end face and of the torque-transmitting surfaces) of the wedge-shaped recesses. Material stresses can thus be reduced and the production of the geometry (for example by means of grinding) can be made possible.

According to a preferred embodiment, the torque-transmitting surface can be formed as a continuously oblique surface between the bevel and the radius. This means that the torque-transmitting surfaces, aside from their respective transition region to the end face pair, are formed as flat surfaces, i.e., without depressions, steps or elevations. The torque transmission is thus ensured and a production of the torque-transmitting surfaces is simplified.

According to a preferred embodiment, the torque-transmitting surfaces between the bevel and the radius can abut continuously against one another. This means that the wedge-shaped protrusion sections or the torque-transmitting surfaces, respectively-aside from their respective transition region to the end face pair-abut flat against one another over the entire extension thereof. Particularly high torques can thus be transmitted.

The axial end faces of cutting head and cutting head driver facing one another can further each be axially stepped by means of their respective protrusion section, so that a Z-shaped contour develops in each case.

Such a Z-shaped contour has proven to be particularly advantageous with regard to its functionality and producibility.

According to a preferred embodiment, the cutting tool can have at least one cooling duct, which is formed by means of a workpiece-side cooling duct section formed in the cutting head and a shaft-side cooling duct section formed in the cutting head driver. This means that a cooling duct for supplying cutting edges of the cutting tool with cooling lubricant extends through the entire cutting tool, is supplied at a shaft-side interface, for instance in the form of a cooling lubricant supply, in the region of the cutting head driver, and is discharged again at a workpiece-side interface, for instance in the form of cooling lubricant outlet opening, in the region of the cutting head. The cutting edges can thus be cooled sufficiently during the machining of the workpieces.

According to a further development of the preferred embodiment, the shaft-side cooling duct section in the region of the end face of the main body of the cutting head driver can transition/lead into the workpiece-side cooling duct section in the region of the end face of the protrusion section of the cutting head. This means that the transfer of the cooling lubricant takes place in the region of the axially abutting contact between the cutting head and the cutting head driver takes place in order to provide for an, in particular laterally tight transfer of the cooling lubricant. Due to the fact that the end face of the protrusion section of the cutting head is pushed in a lever-like manner in the direction of the end face of the main body of the cutting head driver due to the structural formation of the torque-transmitting surface, a tight transition can be created for the cooling lubricant between the cutting head and the cutting head driver, at which no cooling lubricant escapes, preferably even without separate sealing components or sealants. An efficient cooling lubricant supply can thus be ensured.

According to a further development of the preferred embodiment, the cutting head can have at least one end cutting edge and a clearance surface adjoining the end cutting edge, wherein the cooling duct exits from the cutting tool in the region of the clearance surface. In other words, the cooling lubricant escapes on a workpiece-side end face of the cutting tool. A separate cooling duct can preferably be provided for each end cutting edge in order to be able to systematically supply the cooling lubricant to the highly stressed points of the cutting tool.

According to a preferred embodiment, the cutting tool can have at least one helically extending circumferential cutting edge. The circumferential cutting edge can preferably start at one cutting edge corner of the at least one end cutting edge. The number of circumferential cutting edges can in particular correspond to the number of end cutting edges.

According to a further development of the preferred embodiment, the at least one circumferential cutting edge can be formed on the cutting head and the cutting head driver. This means that the circumferential cutting edge is not formed exclusively by the cutting head or the cutting head driver but axially continuously over the extension of the cutting head and of the cutting head driver. A coiling of the at least one circumferential cutting edge is therefore not interrupted or changed by means of the multi-piece formation with cutting head and cutting head driver. The circumferential cutting edge is thus formed axially in section by the cutting head and axially in sections by the cutting head driver. A clamping groove adjoining the at least one circumferential cutting edge can accordingly likewise be formed axially continuously over the extension of the cutting head and of the cutting head driver, i.e., axially in sections through the cutting head and axially in sections through the cutting head driver.

According to a further development of the preferred embodiment, the cutting tool can have several circumferential cutting edges, preferably two circumferential cutting edges. According to the further development of the preferred embodiment, the cutting head and the cutting head driver can in each case have a number of protrusion sections corresponding to the number of circumferential cutting edges. In the case of two circumferential cutting edges, an angular range of 180° thus forms, within which the two protrusion sections as well as a sufficiently large clearance for providing the mutual rotation of the cutting head and of the cutting head driver are arranged. This has the advantage that a sufficiently large formation of the protrusion sections is provided for the power transmission in the case of ensured rotatability.

According to a preferred embodiment, the cutting head driver can have two protrusion sections, which lie diametrically opposite one another and which are formed by means of a web extending over the entire cutting tool diameter. This means that the two protrusion sections of the cutting head driver are connected to one another via a central section. The web can in particular have the central section and the protrusion sections, which extend radially outward therefrom and which are formed, for example, in a wing-like manner.

According to a preferred embodiment, the cutting head can have two protrusion sections, which lie diametrically opposite one another and which are formed so as to be spaced apart from one another in the radial direction/individually/as individual pins. This means that a central recess, with which the central section of the cutting head driver can engage, is formed between the two protrusion sections of the cutting head.

According to a preferred embodiment, the cutting head can have two protrusion sections, which lie diametrically opposite one another and which are formed by means of a web extending over the entire cutting tool diameter. This means that the two protrusion sections of the cutting head are connected to one another via a central section. The web can in particular have the central section and the protrusion sections, which are formed, for example, in a wing-like manner and which extend radially outward therefrom, for example in a fan-like manner.

According to a preferred embodiment, the cutting head driver can have two protrusion sections, which lie diametrically opposite one another and which are formed to be spaced apart from one another in the radial direction/individually/as individual pins. This means that a central recess, with which the central section of the cutting head can engage, is formed between the two protrusion sections of the cutting head driver.

According to a preferred embodiment, an axial contact surface between the cutting head and the cutting head driver can have a central section and wing sections extending radially outward therefrom, for example in a fan-like manner. This means that the axial contact surface is preferably formed on the web extending over the axis of rotation, in particular extending over the entire cutting tool diameter. A sufficient axial bearing surface is thus provided. A transition of the cooling duct between the cutting head and the cutting head driver is in particular also arranged in the axial contact surface.

According to a further development of the preferred embodiment, the wing sections, starting at the central section, can initially taper, in particular on both sides in the circumferential direction, and can subsequently widen again, in particular on both sides in the circumferential direction. This means that the wing sections are in each case formed in a tapered manner, i.e., essentially have an hourglass shape. The wing sections can, at least on one side, in particular have an essentially concavely shaped side edge, which is arranged on the contact surface to the cutting head or cutting head driver, respectively. The wing sections can preferably have essentially concavely shaped side edges on both sides. The one of the concavely shaped side edges is thereby part of the clamping groove and the other one of the concavely shaped side edges is part of the contact surface to the cutting head or cutting head driver, respectively. A geometry, which is particularly suitable with regard to torque transmission and centering, for abutting between the cutting head and the cutting head driver in the circumferential direction/cutting direction, can be realized by means of such a concave shape.

According to a further development of the preferred embodiment, the axial contact surface can be formed to be essentially tapered twice. A geometry, which is particularly suitable with regard to torque transmission and centering, can be realized by means of such a shape, which is tapered twice.

According to a preferred embodiment, a circumferential contact surface between the cutting head and the cutting head driver can be formed so as to be curved in the radial direction. This means that the contact surface, on which the cutting head and the cutting head driver abut against one another in the circumferential direction/cutting direction, is not aligned in a straight line or exactly, respectively, or essentially in the radial direction. The circumferential contact surface, which is formed on the cutting head or at the continuous web, respectively, is in particular curved essentially concavely and the circumferential contact surface, which is complementary thereto and which is formed on the cutting head driver or at the individual pins, respectively, is curved essentially convexly. Due to such a formation, the circumferential contact surface can serve for the torque transmission between cutting head and cutting head driver as well as for the centered alignment of the cutting head to the cutting head driver. Peak stresses in the material are avoided at the same time.

According to a further development of the preferred embodiment, the circumferential contact surface can have a radially inner section and a radially outer section (with respect to the radially inner section), which serve as the torque-transmitting surfaces. This means that the radially inner section extends in a region, which is spaced apart radially inward with respect to the tool diameter, and the radially outer section extends in a region, which is radially spaced apart radially outward with respect to the axis of rotation. A surface extending particularly far in the radial direction can thus be used for the torque transmission. The radially inner section and the radially outer section of the circumferential contact surface can thereby predominantly or exclusively/solely serve for the torque transmission. Alternatively, there can be further surfaces, which contribute to the torque transmission between the cutting head and the cutting head driver.

According to a further development of the preferred embodiment, the radially outer section can extend all the way to the tool diameter (viewed in the radial direction). A transmission of particularly high torques can be ensured by means of the radially external arrangement of the radially outer section.

According to a further development of the preferred embodiment, the radially inner section can extend all the way to the axis of rotation (viewed in the radial direction). The radially internal region can thus also be used for the torque transmission.

According to a further development of the preferred embodiment, the radially inner section of the circumferential contact surface, which is formed on the cutting head or on the continuous web, respectively, can be curved essentially convexly in the radial direction, and the radially inner section of the circumferential contact surface, which is complementary thereto and which is formed on the cutting head driver or on the individual pins, respectively, can be curved essentially concavely in the radial direction. The radially inner section can in particular be arranged in the region of the central section of the axial contact surface.

According to a further development of the preferred embodiment, the radially outer section of the circumferential contact surface, which is formed on the cutting head or on the continuous web, respectively, can be curved essentially concavely in the radial direction, and the radially outer section of the circumferential contact surface, which is complementary thereto and which is formed on the cutting head driver or on the individual pins, respectively, can be curved essentially convexly in the radial direction. The radially outer section can in particular be arranged in the region of the wing section, in particular in the widening region of the wing section, of the axial contact surface.

According to a further development of the preferred embodiment, the radially inner section and the radially outer section can in each case have a radius of curvature, which is eccentric to the axis of rotation, i.e., not concentric to the axis of rotation. It is ensured thereby that the torques acting during the workpiece machining can be transmitted between the cutting head and the cutting head driver.

According to a further development of the preferred embodiment, the circumferential contact surface can have a clamping section, which lies between the radially inner section and the radially outer section in the radial direction and which serves predominantly or exclusively as clamping surface. This means that the radially inner section and the radially outer section are spaced apart from one another in the radial direction. The clamping section lying therebetween can thereby be formed so that it hardly or not at all serves for/contributes to the torque transmission.

According to a further development of the preferred embodiment, the torque-transmitting surfaces formed by means of the radially inner section and the radially outer section can extend over maximally half of the axial extension of the protrusion sections in the axial direction. This means that the bevel and the radius, via which the torque-transmitting surfaces transition into the end faces of the protrusion section or main body, respectively, take up a majority of the axial extension of the respective protrusion section.

The protrusion section of the cutting head can preferably have an essentially oval cross section. The protrusion section of the cutting head can in particular have two essentially semi-circular or C-shaped circumferential sections, respectively, lying opposite one another in the circumferential direction, as well as two essentially straight circumferential sections lying opposite one another in the circumferential direction. One of the semi-circular or C-shaped circumferential sections, respectively, thereby transitions into a respective one of the straight circumferential sections. This means that the straight circumferential sections connect tangentially to the semi-circular or C-shaped circumferential sections, respectively.

The torque-transmitting surface of the cutting head can in particular be formed by means of (outer) circumferential surfaces (alternatively by means of (inner) circumferential surfaces) of the protrusion section of the cutting head. The torque-transmitting surface of the cutting head driver can accordingly be formed by means of (inner) circumferential surfaces (alternatively by means of (outer) circumferential surfaces) of the protrusion section of the cutting head driver. The torque-transmitting surfaces of the cutting head and of the cutting head driver are in particular those circumferential surfaces, on which the cutting head and the cutting head driver abut against one another in the connected state.

According to a preferred embodiment, the torque-transmitting surfaces can be formed by means of curved sections with different radii. This means that the essentially semi-circular or C-shaped circumferential sections, respectively, are formed, in turn, by means of individual curved sections, so that the curvature changes over the curved course of the circumferential sections. The curved sections can preferably be formed in such a way that they merge over the circumferential contour, i.e., the course in the circumferential direction/the circumferential extension. This means that the transition of the different radii takes place without bend or visible edge/seam.

According to a preferred embodiment, the torque-transmitting surfaces can have at least one first curved section and a second curved section, which lies therebehind, in particular directly, in the cutting direction, wherein the second curved section has a smaller radius than the first curved section. The insertion of the cutting head into the cutting head driver is guided or simplified thereby, respectively, and/or a gentle stop is provided. According to an alternative embodiment, the first curved section can have a smaller radius than the second curved section.

According to a further development of the preferred embodiment, the radius of the first curved section and the radius of the second curved section can have different center points. This has the advantage that a seamless transition between the two curved sections can be implemented.

According to a further development of the preferred embodiment, the center point of the second curved section can lie behind the center point of the first curved section, preferably by a small amount, in particular by 0.1 mm to 0.4 mm, in the cutting direction. According to an alternative further development of the preferred embodiment, the center point of the second curved section can lie in front of the center point of the first curved section, preferably by a small amount, in particular by 0.1 mm to 0.4 mm, in the cutting direction. Due to the slight offset of the center points, an edge-free transition between the two curved sections can be established.

According to a preferred embodiment, the torque-transmitting surfaces can have a third curved section, which lies behind, in particular directly, the second curved section in the cutting direction, and the radius of which is significantly larger than the radius of the first and/or second curved section. The third section can be formed, for example, to be almost straight. The insertion of the cutting head into the cutting head driver is simplified thereby.

According to a preferred embodiment, a circumferential surface of the cutting head can be curved essentially convexly in the region of the circumferential contour, in which it abuts against the cutting head driver in the connected state and can be curved essentially concavely in the region of the circumferential contour, in which it does not abut against the cutting head driver in the connected state.

According to a preferred embodiment, the cutting head can have a centering protrusion, which preferably has a circular cross section and/or which is preferably aligned concentrically to the axis of rotation of the cutting tool and which protrudes in the axial direction from the end face of the protrusion section of the cutting head. During the axial insertion into the cutting head driver, the cutting head is thereby guided, whereby the rotatability for forming the bayonet closure remains possible at the same time.

According to a further development of the preferred embodiment, the torque-transmitting surface of the cutting head can have an axial extension, which is essentially twice as large as the centering protrusion. A sufficient centering during the insertion of the cutting head is thus ensured.

### BRIEF DESCRIPTION OF THE DRAWINGS

FIG. 1 is a perspective illustration of a section of a cutting tool with a cutting head and a cutting head driver according to a first embodiment of the present disclosure;

FIG. 2 is a perspective illustration of the cutting tool in an unconnected state of the cutting head and of the cutting head driver;

FIG. 3 is a side view of the cutting tool in the unconnected state;

FIG. 4 is a side view of the cutting tool in a connected state of the cutting head and of the cutting head driver;

FIG. 5 is a side view of the cutting tool rotated about a longitudinal axis of the cutting tool, compared to FIG. 4, in the connected state;

FIG. 6 is an enlarged illustration of a detail from FIG. 5;

FIG. 7 is a view from the bottom onto the cutting head;

FIG. 8 is a view from the top onto the cutting head driver;

FIG. 9 is a perspective illustration of a section of the cutting tool according to a second embodiment of the present disclosure;

FIG. 10 is a perspective illustration of the cutting tool in an unconnected state of the cutting head and of the cutting head driver;

FIG. 11 is a side view of the cutting tool in the unconnected state;

FIGS. 12 and 12A are side views of the cutting tool in an unconnected state of the cutting head and of the cutting head driver;

FIG. 13 is a side view of the cutting tool rotated about a longitudinal axis of the cutting tool compared to FIGS. 12 and 12A in the connected state;

FIG. 14 is an enlarged illustration of a detail from FIG. 12A;

FIG. 15 is a view from the bottom onto the cutting head;

FIG. 16 is a view from the top onto the cutting head driver;

FIGS. 17 and 18 are perspective illustrations of the cutting head and of the cutting head driver;

FIGS. 19 and 20 are perspective illustrations of the cutting head according to a third embodiment of the present disclosure;

FIG. 21 is a view from the bottom onto the cutting head;

FIGS. 22 and 23 are side views of the cutting head;

FIG. 24 is a perspective illustration of the cutting head driver according to the second embodiment of the present disclosure;

FIG. 25 is a view from the top onto the cutting head driver;

FIG. 26 is a longitudinal sectional illustration of the cutting head driver;

FIG. 27 is an illustration of the principle of a cutting tool from the prior art; and

FIG. 28 is an illustration of the principle of the cutting tool according to the present disclosure.

### DETAILED DESCRIPTION

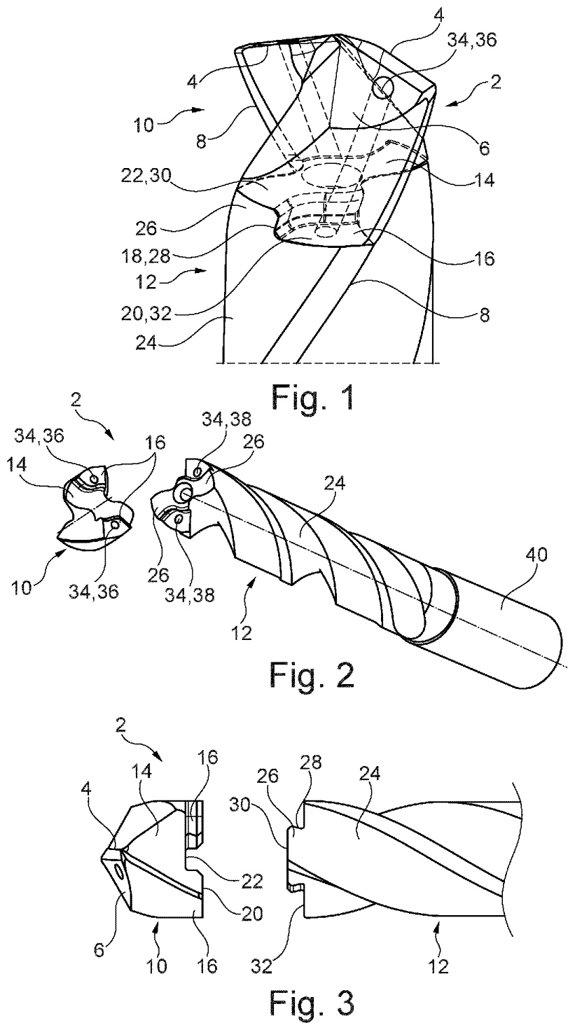

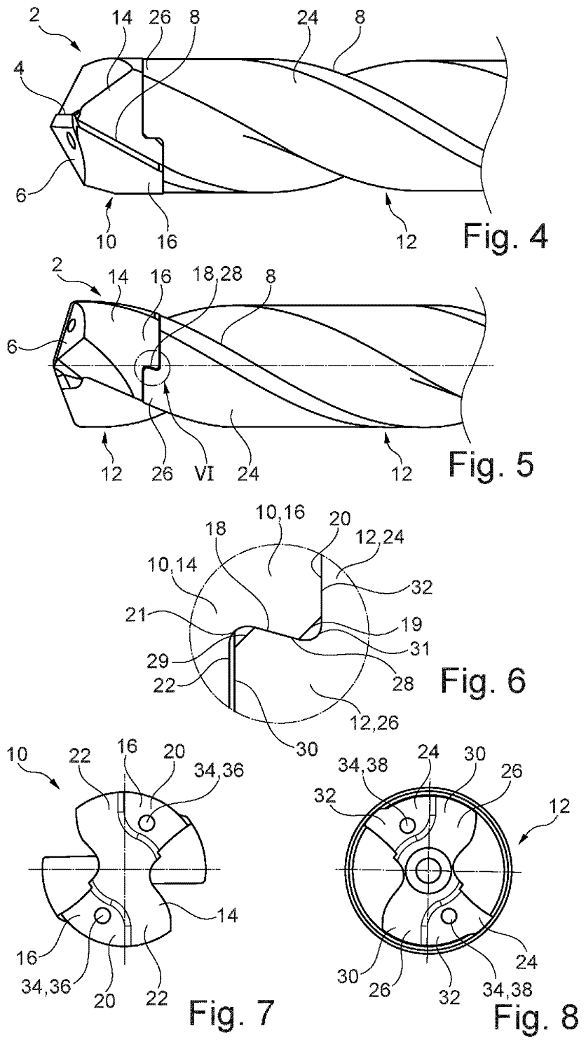

FIGS. 1 to 8 show different illustrations of a cutting tool 2 according to a first embodiment of the present disclosure or cutouts, respectively, and individual parts thereof. The cutting tool 2 serves the purpose of machining workpieces. The cutting tool 2 is formed as a shaft tool, such as a milling cutter or a drill.

The cutting tool 2 has at least one end cutting edge, preferably several, in the illustrated embodiment two, end cutting edges 4, which are formed on an end face of the cutting tool 2. A (main) clearance surface 6 adjoins the end cutting edges 4 in each case.

The cutting tool 2 has at least one circumferential cutting edge, preferably several, in the illustrated embodiment two, circumferential cutting edges 8. The circumferential cutting edges 8 extend helically over an outer side of the cutting tool 2. Each circumferential cutting edge 8 can in particular start at one cutting edge corner of a respective one of the end cutting edges 4.

The cutting tool 2 is constructed of multiple pieces and has a cutting head 10 (cutting attachment) as well as a cutting head driver 12 (carrier). The cutting head 10 and the cutting head driver 12 adjoin one another in the axial direction of the cutting tool 2, wherein the cutting head 10 forms a workpiece-side section and the cutting head driver 12 forms a shaft-side section. The cutting head 10 and the cutting head driver 12 can be (releasably) connected to one another via a type of bayonet closure/a bayonet connection. In a connected state, the cutting head 10 and the cutting head driver 12 are connected to one another/attached to one another in a torque-transmitting as well as in an axially fixed manner. By means of mutual rotation in a first direction of rotation to one another, for instance by rotating the cutting head 10 against a cutting direction of the cutting tool 2, the cutting head 10 and the cutting head driver 12 can be connected to one another in a positive manner. By means of mutual rotation in a second direction of rotation to one another (against the first direction of rotation), for instance by rotating the cutting head 10 in a cutting direction of the cutting tool 2, the cutting head 10 and the cutting head driver 12 can be released from one another.

The end cutting edges 4 of the cutting tool 2 are formed on the cutting head 10. The circumferential cutting edges 8 of the cutting tool 2 are formed (in sections) on the cutting head 10 as well as (in sections) on the cutting head driver 12. The circumferential cutting edges 8 thus extend continuously in the axial direction, i.e., also via the connection between cutting head 10 and cutting head driver 12. The bayonet connection, via which the cutting head 10 and the cutting head driver 12 can be connected, is therefore arranged within a cutting section of the cutting tool 2.

The cutting head 10 and the cutting head driver 12 can be made of/formed/produced from different materials/substances. The cutting head 10 can preferably be made of hard metal. The cutting head driver 12 can preferably be made of steel.

Alternatively to the described embodiment, the cutting head 10 and the cutting head driver 12 can both further be made of the same material/substance group, e.g., both of steel, as long as the material properties thereof differ and it is ensured that the loads resulting from the wedge forces are moved into that section, which, by comparison, is the more flexurally elastic, softer or less brittle section, in the case of a bayonet-like connection between sections of the cutting head 10 and of the cutting head driver 12 with an alternate interior angle geometry or with two wedge geometries, respectively, mutually engaging behind one another.

The cutting head 10 has a main body 14, from the end face of which a protrusion section 16 protrudes axially. The protrusion section 16 protrudes in the direction to the cutting head driver 12 and serves for the bayonet-like fastening to the cutting head driver 12. The protrusion section 16 is formed to be undercut in the axial direction and has a torque-transmitting surface 18, which is preferably formed so as to be adjusted in the axial direction. The torque-transmitting surface 18 is preferably formed essentially in the radial direction, i.e., perpendicular to the tangential direction, so as to be able to transmit a torque. An end face of the cutting head 10 (facing the cutting head driver 12/facing away from the workpiece) is formed in an axially stepped manner by means of the protrusion section 16, so that an essentially Z-shaped contour develops. The Z-shaped contour is formed by means of an axial end face 20 of the protrusion section 16, the axially adjusted torque-transmitting surface 18 of the protrusion section 16 and an axial end face 22 of the main body 14. The axial end face 20 of the protrusion section 16 thereby transitions into the torque-transmitting surface 18 via a bevel 19. The torque-transmitting surface 18 transitions into the axial end face 22 of the main body 14 via a radius 21.

The cutting head 10 has a number of protrusion sections 16 corresponding to the number of circumferential cutting edges 8. This means that in the illustrated embodiment, the cutting head 10 has two protrusion sections 16. The two protrusion sections 16 are arranged so as to lie diametrically opposite one another. The protrusion sections 16 of the cutting head 10 are formed so as to be spaced apart from one another/individually in the radial direction. This means that they are separated from one another via a central recess/not connected to one another continuously over the cutting tool diameter.

Alternatively, the protrusion sections 16 can also be formed (in the case of corresponding formation of the cutting head driver 12) by means of a web, which extends continuously over the cutting tool diameter.

The cutting head driver 12 has a main body 24, from the end face of which a protrusion section 26 protrudes axially. The protrusion section 26 protrudes in the direction to the cutting head 10 and serves for the bayonet-like fastening to the cutting head 10. The protrusion section 26 is formed to be undercut in the axial direction and has a torque-transmitting surface 28, which is preferably formed to be adjusted in the axial direction. The torque-transmitting surface 28 is preferably formed essentially in the radial direction, i.e., perpendicular to the tangential direction, so as to be able to transmit a torque. An end face of the cutting head driver 12 (facing the cutting head 10/facing away from the shaft) is formed in an axially stepped manner by means of the protrusion section 26, so that an essentially Z-shaped contour develops. The Z-shaped contour is formed by means of an axial end face 30 of the protrusion section 26, the axially adjusted torque-transmitting surface 28 of the protrusion section 26 and an axial end face 32 of the main body 24. The axial end face 30 of the protrusion section 26 thereby transitions into the torque-transmitting surface 28 via a bevel 29. The torque-transmitting surface 28 transitions into the axial end face 32 of the main body 24 via a radius 31.

The cutting head driver 12 has a number of protrusion sections 26 corresponding to the number of circumferential cutting edges 8. This means that the cutting head driver 12 has two protrusion sections 26 in the illustrated embodiment. The two protrusion sections 26 are arranged so as to lie diametrically opposite one another. The two protrusion sections 26 are formed by means of a web extending over the entire cutting tool diameter. This means that the protrusion sections 26 are connected continuously to one another over the cutting tool diameter.

Alternatively, the protrusion sections 26 can also be formed (in the case of corresponding formation of the cutting head 10) to be spaced apart from one another in the radial direction/individually.

The torque-transmitting surface 18 of the cutting head 10 and the torque-transmitting surface 28 of the cutting head driver 12 are formed complementary to one another, so that they abut against one another (flat) in the connected state. The cutting head 10 and the cutting head driver 12 are axially pushed towards one another/axially clamped in the connected state by means of the adjusted formation/inclination of the torque-transmitting surfaces 18, 28 and the lever action resulting therefrom.

According to the present disclosure, the protrusion sections 16, 26 of the cutting head 10 and of the cutting head driver 12 are dimensioned so that the end face 20 of the protrusion section 16 of the cutting head 10 abuts against the end face 32 of the main body 24 of the cutting head driver 12 in the axial direction in the connected state. The protrusion section 16 of the cutting head 10 thus supports itself on the main body 24 of the cutting head driver 12.

The end face 30 of the protrusion section 26 of the cutting head driver 12 is additionally spaced apart from the end face 22 of the main body 14 of the cutting head 10 with axial play in the connected state. The main body 14 of the cutting head 10 thus does not support itself on the protrusion section 26 of the cutting head driver 12.

The protrusion section 16 of the cutting head 10 can preferably be formed to be (slightly) longer the axial direction than the protrusion section 26 of the cutting head driver 12 in.

The cutting tool 2 further has at least one cooling duct, preferably several, in the illustrated embodiment two cooling ducts 34. The cooling ducts 34 serve the purpose of supplying cooling lubricant to stressed points of the cutting tool 2, in particular to the cutting edges, as well as the end cutting edges 4.

The cooling ducts 34 can in particular exit from the cutting tool 2 in the region of the clearance surfaces 6.

The cooling ducts 34 are in each case formed by means of a workpiece-side cooling duct section 36 formed in the cutting head 10 and a shaft-side cooling duct section 38 formed in the cutting head driver 12. The cooling lubricant can preferably be supplied centrally and can be distributed to the shaft-side cooling duct sections 38.

The shaft-side cooling duct section 38 leads into the workpiece-side cooling duct section 36 in a region, in which the cutting head driver 12 abuts flush, preferably tightly, against the cutting head 10. In the illustrated embodiment, the cooling duct section 38 transitions into the cooling duct section 36 in the region of the end face 32 of the main body 24 of the cutting head driver 12 or in the region of the end face 20 of the protrusion section 16 of the cutting head 10, respectively.

The cutting tool 2 has a shaft section 40, via which the cutting tool 2 can be clamped into a tool receptacle and can be rotationally driven. The shaft section 40 adjoins the cutting head driver 12 in the axial direction on a side facing away from the cutting head 10.

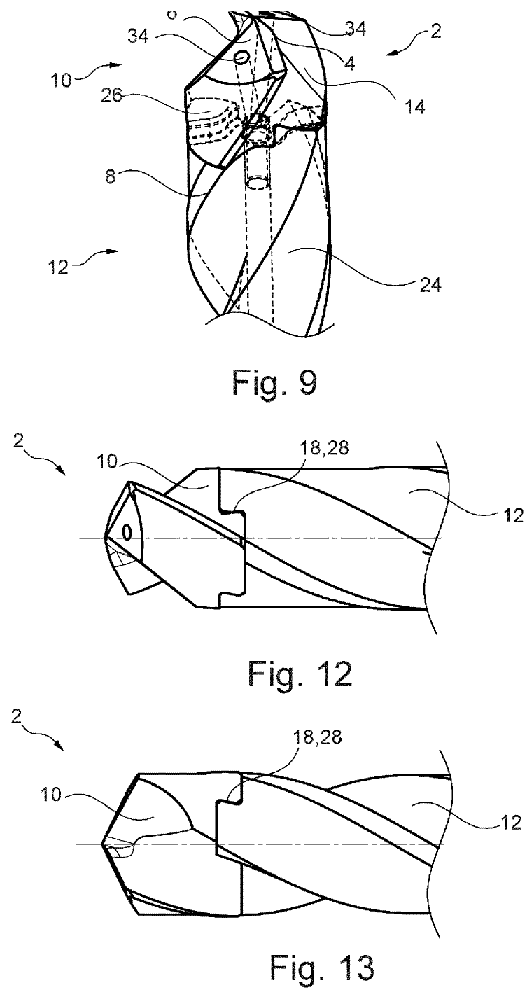

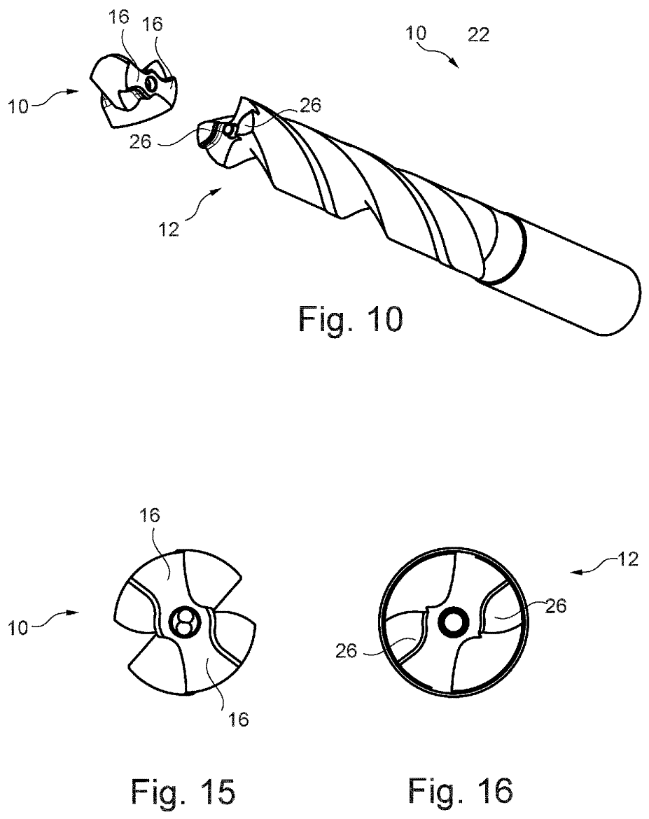

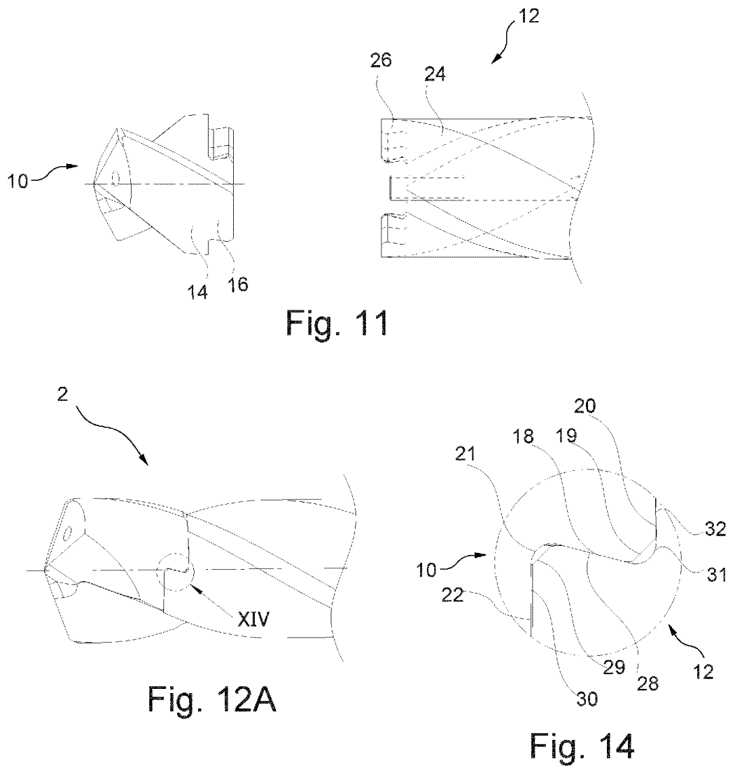

FIGS. 9 to 18 show a second embodiment of the cutting tool 2. The second embodiment largely has the same features as the first embodiment, so that only the differences will be described in the following.

The two protrusion sections 16 of the cutting head 10 are formed by means of a web extending over the entire cutting tool diameter. This means that the protrusion sections 16 are connected to one another continuously over the cutting tool diameter. The two protrusion sections 26 of the cutting head driver 12 are arranged so as to lie diametrically opposite one another. The protrusion sections 26 of the cutting head driver 12 are formed spaced apart from one another in the radial direction/individually. This means that they are separated from one another via a central recess/not connected to one another continuously over the cutting tool diameter.

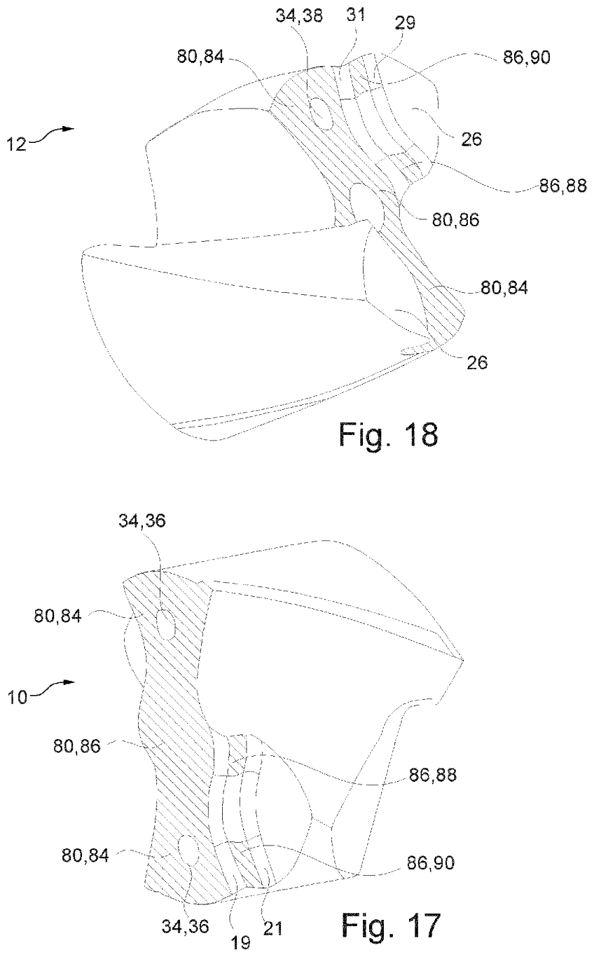

FIGS. 17 and 18 show perspective illustrations of the cutting head 10 and of the cutting head driver 12, by means of which a particularly advantageous design of the protrusion sections 16, 26 will be described in the following. The contact surfaces, on which the cutting head 10 and the cutting head driver 12 abut against one another, are illustrated in a shaded manner in the perspective illustrations.

An axial contact surface 80 is formed on the axial end face 20 of the continuous web of the protrusion sections 16 of the cutting head 10 and the complementary surface thereof on the axial end face 32 of the main body 24 or of the recess between the protrusion sections 26 of the cutting head driver 12, respectively. The axial contact surface 80 has a central section 82 and two wing sections 84, which extend radially outward therefrom, for example in a fan-like manner. The wing sections 84 are formed in a tapered manner, so that they initially taper from the central section 82 and subsequently widen again.

A circumferential contact surface 86 is formed on the side surface of the protrusion sections 16 of the cutting head 10, which is transverse to the cutting direction, and the complementary surface on the side surface of the protrusion sections 26 of the cutting head driver 12, which is transverse to the cutting direction. The circumferential contact surface 86 is formed to be curved in the radial direction. The circumferential contact surface 86 formed on the cutting head side is curved essentially concavely and the circumferential contact surface 86 formed on the cutting head driver side is correspondingly curved essentially convexly.

The circumferential contact surface 86 has a radially inner section 88 and a radially outer section 90. The sections 88, 90 serve as the torque-transmitting surfaces 18, 28. The radially inner section 88 is radially spaced apart inward radially with respect to the tool diameter. The radially outer section 90 is arranged radially outside of the radially inner section 88 and is radially spaced apart outward radially with respect to the axis of rotation. The radially outer section 90 extends all the way to the tool diameter, viewed in the radial direction. The radially inner section 88 extends all the way to the axis of rotation, viewed in the radial direction.

The radially inner section 88 is curved essentially convexly on the circumferential contact surface 86, which is formed on the cutting head side and is correspondingly curved essentially concavely on the circumferential contact surface 86, which is formed on the cutting head driver side. The radially outer section 90 is curved essentially concavely on the circumferential contact surface 86, which is formed on the cutting head side and is accordingly curved essentially convexly on the circumferential contact surface 86 formed on the cutting head driver side. The radially inner section 88 and the radially outer section 90 in each case have a radius of curvature, which is eccentric to the axis of rotation, i.e., not concentric to the axis of rotation.

The circumferential contact surface 86 has a clamping section 92, which lies between the radially inner section 88 and the radially outer section 90 in the radial direction and which serves predominantly or exclusively as clamping surface (and preferably hardly or not for the torque transmission). This means that the radially inner section 88 and the radially outer section 90 are spaced apart from one another in the radial direction.

The torque-transmitting surfaces 18, 28 formed by means of the radially inner section 88 and the radially outer section 90 extend over maximally half of the axial extension of the protrusion sections 16, 26 in the axial direction. This means that the bevel 19, 29 and the radius 21, 31, via which the torque-transmitting surfaces 18, 28 transition into the end faces 20, 22, 30, 32 of the protrusion section 16, 26 or main body 14, 24, respectively, take up a majority of the axial extension of the respective protrusion section 16, 26.

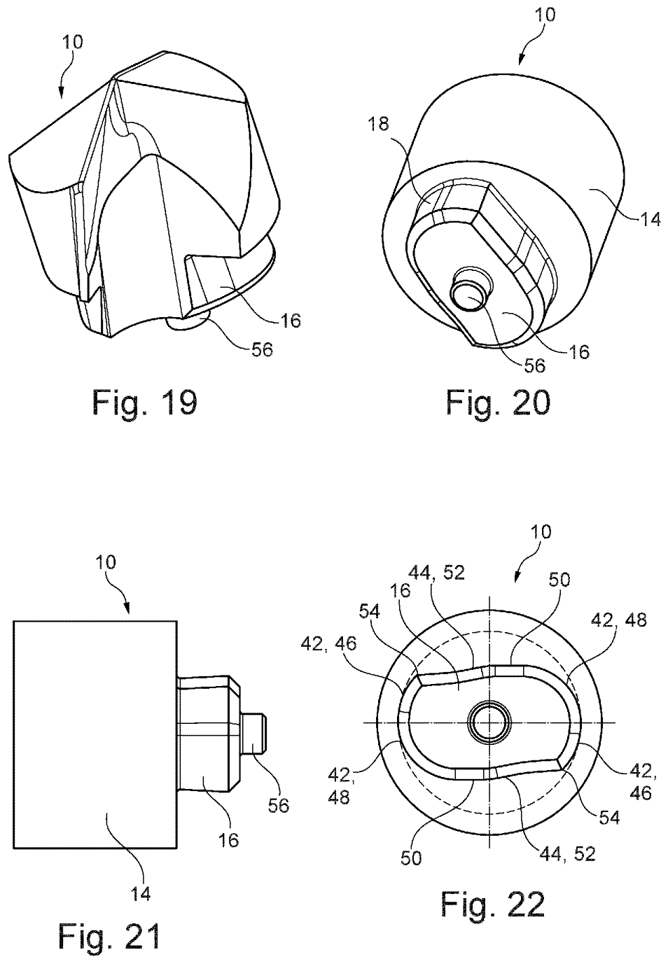

FIGS. 19 to 26 show a third embodiment of the cutting tool 2, on the basis of which a particularly advantageous design of the protrusion sections 16, 26 or in particular of the structural design of the torque-transmitting surfaces 18, 28, respectively, will be described in the following.

FIGS. 19 to 23 show different views of the cutting head 10. The cutting head 10 has the main body 14, from the end face of which the protrusion section 16, which is undercut in the axial direction, protrudes axially. The protrusion section 16 of the cutting head 10 has an essentially oval cross section. The protrusion section 16 in particular has two first circumferential sections 42 lying opposite one another and two second circumferential sections 44 lying opposite one another, which in each case merge. The first circumferential sections 42 are curved convexly and have an essentially semi-circular or C-shaped contour. The second circumferential sections 44 have a contour, which is essentially straight or curved very weakly concavely.

The first circumferential sections 42 in each case consist of several curved sections 46, 48 with different radii. The first circumferential sections 42 in particular in each case have a first curved section 46 and a second curved section 48, which lies therebehind, in particular directly, in the cutting direction. The first curved section 46 extends approximately over an octant of a circle. The second curved section 48 extends approximately over a quarter circle.

The second curved section 48 has a smaller radius than the first curved section 46. The radius of the first curved section 46 and the radius of the second curved section 48 have different center points. The center point of the second curved section 48 thereby lies behind the center point of the first curved section 46, preferably by a small amount, in particular by 0.1 mm to 0.4 mm, in the cutting direction.

The first circumferential sections 42 in each case transition 50 into the second circumferential sections 44 via a transition section 50. The transition section 50 lies behind, in particular directly, the second curved section 48 in the cutting direction. The transition section 50 has a radius, which is larger than the radius of the second curved section 48. The transition section 50 is adjoined in the circumferential direction by the second circumferential section 44, which, in the illustrated embodiment, is formed by a third curved section 52, which is curved weakly concavely. This means that the radius of the third curved section 52 is significantly larger, for example at least 8-times as large as the radius of the second curved section 48. The second circumferential section 44, in turn, is adjoined by one of the first circumferential sections 42, wherein an edge 54 is formed between the two circumferential sections 42, 44.

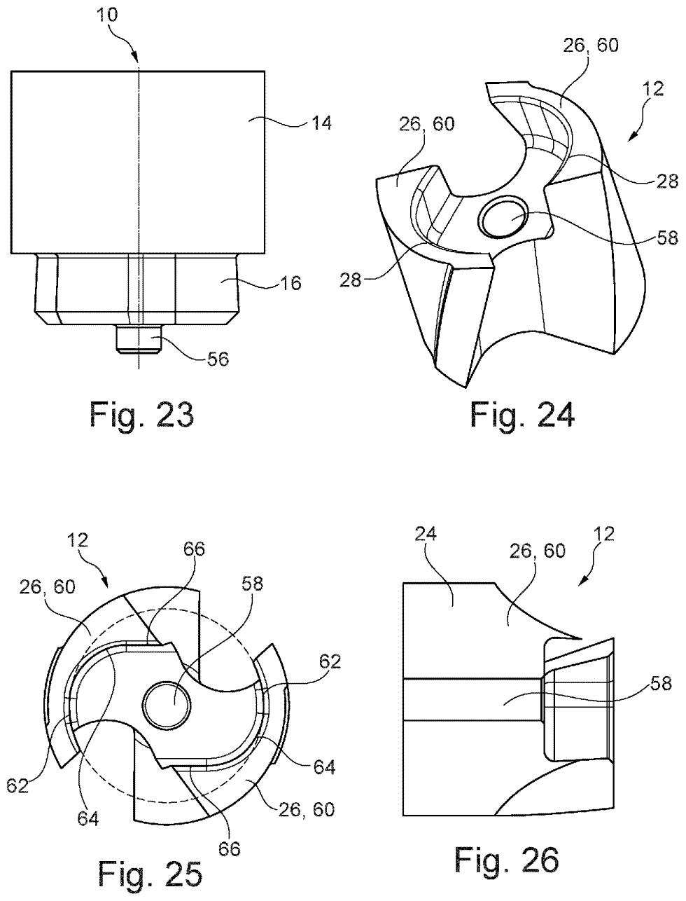

FIGS. 22 and 23 show side views of the cutting head 10. It can be seen therein that the protrusion section 16 extends directly from the main body 14. The Z shape results therefrom, which is formed by the end face of the main body 14, the torque-transmitting surface 18 and the end face of the protrusion section 16.

The protrusion section 16 is formed essentially trapezoidal in the longitudinal section, wherein the oblique side surfaces of the trapezoid form the torque-transmitting surface 18 of the cutting head 10. The torque-transmitting surface 18 is inclined with an axial angle of attack, preferably from 2° to 5°, in particular of 3°, to the axial direction.

The axial angle of attack is thereby constant at least over the entire circumferential contour of the torque-transmitting surface, in particular over the entire circumferential contour of the protrusion section 16, i.e., in the region of the first circumferential sections 42 as well as in the region of the second circumferential sections 44. For example, the radii of the different curved sections 46, 48 or of the transition section 50, respectively, or of the circumferential sections 42, 44, respectively, intersect one another. The axial angle of attack is further constant over the entire axial extension of the protrusion section 16. This means that no steps, elevations and depressions are formed in the side surfaces of the protrusion section 16 in the region of the torque-transmitting surface 18 or in the region of the first circumferential sections 42, respectively (and optionally also of the second circumferential sections 44), but the side surfaces are a continuous oblique surface. In other words, the Z shape of the protrusion section 16 is formed identical over the entire circumferential contour.

On its narrowest point, the protrusion section 16 is approximately 1.5- to 3-times, preferably approximately twice, as wide as the protrusion section 16 extends in the axial direction. A sufficiently large axial undercut can be ensured by means of the axial dimensioning.

The cutting head 10 additionally has a centering protrusion 56, which preferably has a circular cross section and/or which is preferably aligned concentrically to the axis of rotation of the cutting tool 2. The centering protrusion 56 protrudes in the axial direction from the end face of the protrusion section 16 of the cutting head 10. In the connected state of the cutting tool 2, the centering protrusion 56 engages with a correspondingly formed recess 58 in the cutting head driver 12. For example, the protrusion section 16 or the torque-transmitting surface 18 of the cutting head 10, respectively, has an axial extension, which is essentially twice as large as the centering protrusion 56.

FIGS. 24 to 26 show different views of the cutting head driver 12. The cutting head driver 12 has the main body 24, from the end face of which the protrusion section 26, which is undercut in the axial direction, protrudes axially. The protrusion section 26 is formed by two webs 60, which lie diametrically opposite one another and which comprise a recess, the shape of which corresponds to the shape of the protrusion section 16 of the cutting head 10. In the connected state of the cutting tool 2, the protrusion section 16 of the cutting head abuts with its outer circumferential surfaces, which serve as torque-transmitting surface 18 of the cutting head, against inner circumferential surfaces of the protrusion section 26 of the cutting head driver 12, which, in turn, serve as torque-transmitting surface 28 of the cutting head driver 12.

The shape of the inner circumferential surfaces of the cutting head driver 12 corresponds to the shape of the first circumferential sections 42 of the cutting head 10. This means that the inner circumferential surfaces of the cutting head driver 12 or the webs 60, respectively, in each case consist of several curved sections with different radii. The webs 60 in particular in each case have a first curved section 62 and a second curved section 64, which lies therebehind, in particular directly, in the cutting direction. The first curved section 62 extends approximately over an octant of a circle. The second curved section 48 extends approximately over a quarter circle.

The second curved section 64 has a smaller radius than the first curved section 62. The radius of the first curved section 62 and the radius of the second curved section 64 have different center points. The center point of the second curved section 64 thereby lies behind the center point of the first curved section 62, preferably by a small amount, in particular by 0.1 mm to 0.4 mm, in the cutting direction.

The two curved sections 62, 64 are adjoined by a transition section 68. The transition section 66 lies behind, in particular directly, the second curved section 64 in the cutting direction. The transition section 66 has a radius, which is significantly larger than the radius of the second curved section 64, so that the transition section 66 is, for example, approximately straight.

The inner circumferential surfaces of the webs 60, which serve as torque-transmitting surface 28, are inclined with the axial angle of attack, preferably from 2° to 5°, in particular of 3° to the axial direction. The axial angle of attack of the torque-transmitting surface 28, thus the axial adjustment of the cutting head driver 12, in particular corresponds to the axial angle of attack of the torque-transmitting surface 18, thus the axial adjustment of the cutting head 10. This means that the cutting head driver 12 and the cutting head 10 are adjusted axially with the same angle of attack. The axial angle of attack is thereby constant over the entire circumferential contour of the torque-transmitting surface 28. For example, the radii of the different curved sections 62, 64 or of the transition section 66, respectively, intersect one another. The axial angle of attack is further constant over the entire axial extension of the protrusion section 26. This means that no steps, elevations and depressions are formed in the region of the torque-transmitting surface 28, but the side surfaces are a continuous oblique surface. In other words, the Z shape of the webs 60 is formed identical over the entire circumferential contour.

The recess 58, with which the centering protrusion 56 engages in the unconnected state of the cutting tool 2, is formed in the cutting head driver 12. In the illustrated embodiment, the recess 58 is formed as a through hole. Alternatively, the recess 58 can also be formed as a blind hole, even though this is not illustrated.

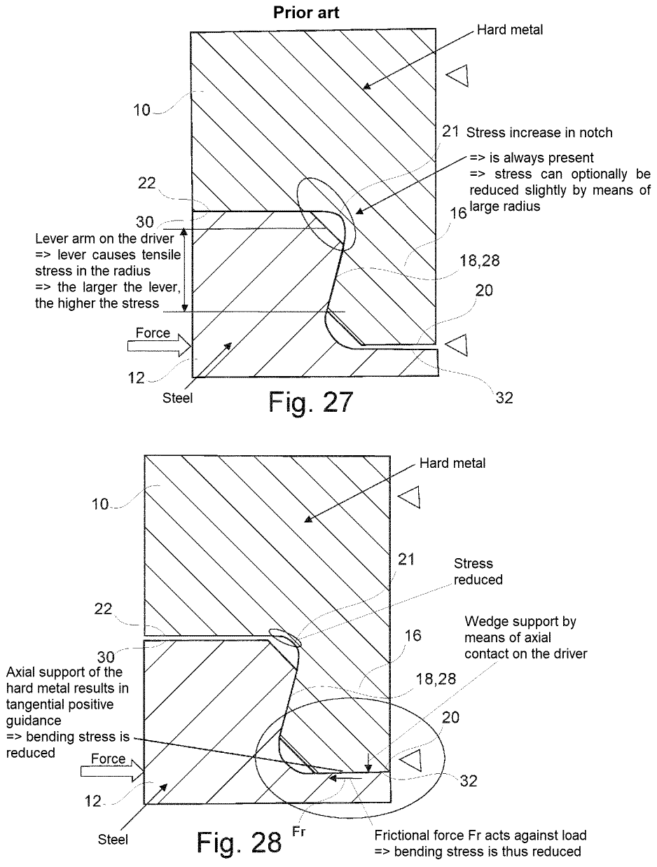

FIGS. 27 and 28 show illustrations of the principle of a cutting tool known from the prior art and of the cutting tool 2 according to the present disclosure, on the basis of which a significant aspect of the cutting tool, which the already described three embodiments have in common, is described once again. FIGS. 27 and 28 are each sectional illustrations in a plane, which is offset in parallel to a longitudinal plane containing the axis of rotation.

As can be seen in FIG. 27, the solution is such in the prior art that the end face 20 of the protrusion section 16 of the cutting head 10 is spaced apart from the end face 32 of the main body 24 of the cutting head driver 12 and that the end face 22 of the main body 14 of the cutting head 10 abuts against the end face 30 of the protrusion section 26 of the cutting head driver 12. This means that in the prior art, an axial gap is formed between the free end of the cutting head 10, in particular of that section forming the torque-transmitting surface 18, namely of the wedge-shaped protrusion section 16 and the cutting head driver 12. In contrast, the free end of the cutting head driver 12, in particular of that section forming the torque-transmitting surface 28, namely of the wedge-shaped protrusion section 26, rests against the cutting head 10. A lever arm is thus created on the cutting head driver 12, whereby a tensile stress is caused, in turn, in the radius 21, wherein the stress becomes larger as the lever becomes larger. This thus leads to a spreading of the wedge-shaped recess of the cutting head 10. In the case of such a construction, the stresses developing thereby in the radius 21/the notch are always present and can be reduced slightly, optionally by means of an enlargement of the radius 21.

As can be seen in FIG. 28, the solution according to the present disclosure, in contrast, is such that the end face 20 of the protrusion section 16 of the cutting head 10 abuts against the end face 32 of the main body 24 of the cutting head driver 12 and that the end face 22 of the main body 14 of the cutting head 10 is spaced apart from the end face 30 of the protrusion section 26 of the cutting head driver 12. This means that in the case of the present disclosure no axial gap is formed between the free end of the cutting head 10, in particular that section forming the torque-transmitting surface 18, namely of the wedge-shaped protrusion section 16 and the cutting head driver 12, but that the cutting head 10 abuts with the end face 20 of the wedge-shaped protrusion section 16 against the cutting head driver 12. This has the effect that a wedge support is present by means of the axial contact of the cutting head 10 with the cutting head driver 12. The axial support of the cutting head results in a tangential positive guidance, so that the bending stress is reduced. The frictional force (developing due to the axial contact) further acts transversely to the axial direction and thus counteracts the stress (developing due to the torque transmission on the torque-transmitting surface 18), whereby the bending stress in the radius 21 is reduced, in turn (compared to the solution of the prior art).

In other words, a force, which, due to the axial adjustment of the torque-transmitting surfaces 18, 28, leads to a spreading of the respective wedge-shaped recesses and thus to a tensile stress in the radius 21, 31, always acts on the torque-transmitting surfaces 18, 28 during the workpiece machining. In the case of the cutting tool 2 of the present disclosure, however, a frictional force is induced by means of the wedge support of the cutting head 10, i.e., the axial contact to the cutting head driver 12, which acts transversely to the axial direction in the direction to the torque-transmitting surfaces 18, 28. This frictional force thus counteracts the spreading of the cutting head 10 (and not a spreading of the cutting head driver 12 as in the prior art), whereby the bending stress can, in turn, be reduced in the region of the radius 21.

1.-44. (canceled)

45. A cutting tool (2) for machining workpieces, comprising:
a cutting head (10); and
a cutting head driver (12) which can be connected to the cutting head (10) via a bayonet closure,
wherein the cutting head (10) has a main body (14) from an end face (20) of which a protrusion section (16) that is axially undercut protrudes axially,
wherein the cutting head driver (12) has a main body (24) from an end face (32) of which a protrusion section (26) that is axially undercut protrudes axially,
wherein the protrusion section (16) of the cutting head (10) and the protrusion section (26) of the cutting head driver (12) can be connected to one another in a positive manner by rotating the cutting head (10) against a cutting direction of the cutting tool (2), and
wherein the protrusion section (16) of the cutting head (10) and the protrusion section (26) of the cutting head driver (12) have torque-transmitting surfaces (18, 28), which are formed complementary to one another, are axially undercut, and abut against one another in a connected state, and
wherein the protrusion section (16) of the cutting head (10) and the protrusion section (26) of the cutting head driver (12) are dimensioned so that the end face (20) of the protrusion section (16) of the cutting head (10) axially abuts against the end face (32) of the main body (24) of the cutting head driver (12) in the connected state.

46. The cutting tool (2) according to claim 45,
wherein a circumferential contact surface (86) between the cutting head (10) and the cutting head driver (12) is formed so as to be curved in a radial direction.

47. The cutting tool (2) according to claim 46,
wherein the circumferential contact surface (86) has a radially inner section (88) and a radially outer section (90), which serve as the torque-transmitting surfaces (18, 28).

48. The cutting tool (2) according to claim 47,
wherein the radially outer section (90) extends to an outer diameter of the cutting tool.

49. The cutting tool (2) according to claim 47,
wherein the radially inner section (88) of the circumferential contact surface, which is formed on the cutting head, is curved essentially convexly in the radial direction, and
wherein the radially inner section (88) of the circumferential contact surface, which is complementary thereto and which is formed on the cutting head driver, is curved essentially concavely in the radial direction.

50. The cutting tool (2) according to claim 47,
wherein the radially outer section (90) of the circumferential contact surface, which is formed on the cutting head, is curved essentially concavely in the radial direction, and
wherein the radially outer section (90) of the circumferential contact surface, which is complementary thereto and which is formed on the cutting head driver, is curved essentially convexly in the radial direction.

51. The cutting tool (2) according to claim 47,
wherein the radially inner section (88) and the radially outer section (90) each have a radius of curvature, which is eccentric to an axis of rotation.

52. The cutting tool (2) according to claim 47,
wherein the circumferential contact surface (86) has a clamping section,
wherein the clamping section lies between the radially inner section and the radially outer section in the radial direction, and
wherein the clamping section serves predominantly or exclusively as clamping surface.

53. The cutting tool (2) according to claim 47,
wherein the torque-transmitting surfaces (18, 28) formed by the radially inner section (88) and the radially outer section (90) extend axially over maximally half of an axial extension of the protrusion sections (16, 26).

54. The cutting tool (2) according to claim 45,
wherein an axial contact surface (80) between the cutting head (10) and the cutting head driver (12) has a central section (82) and wing sections (84) extending radially outward therefrom, and
wherein the wing sections, starting at the central section, initially taper on both sides in a circumferential direction, and subsequently widen on both sides in the circumferential direction.

55. The cutting tool (2) according to claim 45,
wherein the torque-transmitting surfaces (18, 28) are axially adjusted with an axial angle of attack from 2° to 5°.

56. The cutting tool (2) according to claim 55,
wherein a torque-transmitting surface (18) of the cutting head (10) and a torque-transmitting surface (28) of the cutting head driver (12) have identical axial angles of attack.

57. The cutting tool (2) according to claim 45,
wherein the cutting head (10) and the cutting head driver (12) are formed in a Z-shape in a region of the bayonet closure.

58. The cutting tool (2) according to claim 57,
wherein the Z-shape is created by the cutting head (10) and the cutting head driver (12) each having an end face pair of two end faces, which each extend perpendicular to an axial direction and which are spaced apart from one another in the axial direction, and
wherein the torque-transmitting surfaces (18, 28), which connect the two end faces of an end face pair to one another, each extend essentially continuously obliquely to the axial direction between the two end faces of the respective end face pair.

59. The cutting tool (2) according to claim 58,
wherein an axially outer end face of the end face pair transitions into the torque-transmitting surface via a bevel.

60. The cutting tool (2) according to claim 59,
wherein an axially inner end face of the end face pair transitions into the torque-transmitting surface via a radius.

61. The cutting tool (2) according to claim 60,
wherein the torque-transmitting surface (18, 28) is formed as a continuously oblique surface between the bevel and the radius.

62. The cutting tool (2) according to claim 61,
wherein the torque-transmitting surfaces (18, 28) between the bevel and the radius abut continuously against one another.
